(19) United States
(12) Patent Application Publication
(10) Pub. No.: US 2024/0111842 A1
(43) Pub. Date: Apr. 4, 2024

(54) LICENSE AUTHENTICATION METHOD AND APPARATUS, ELECTRONIC DEVICE, SYSTEM, AND STORAGE MEDIUM

(71) Applicant: BOE Technology Group Co., Ltd., Beijing (CN)

(72) Inventor: Xinquan YAN, Beijing (CN)

(21) Appl. No.: 18/267,429

(22) PCT Filed: Dec. 24, 2020
(86) PCT No.: PCT/CN2020/139087

§ 371 Date: Jun. 14, 2023

(51) Int. Cl. G06F 21/10; G06F 21/60

(52) U.S. Cl. CPC G06F 21/105; G06F 21/107; G06F 21/602

(57) ABSTRACT

Provided are a license authentication method and apparatus, an electronic device, a system, and a storage medium. The method includes: obtaining registration information provided by a licensed terminal, wherein the registration information includes a public key and a first environment ciphertext provided by the licensed terminal, the first environment ciphertext is obtained after the licensed terminal encrypts the currently obtained first environment fingerprint by using a private key, and the first environment fingerprint includes the software and hardware feature information of an environment where the licensed terminal is located; generating license information comprising the first environment ciphertext, encrypting the license information by using the public key, and encrypting the encrypted license information in a homomorphic mode to obtain a license ciphertext indicating a license range of a service to be licensed for which the licensed terminal requests license authentication; and transmitting the license ciphertext to the licensed terminal.

### CROSS REFERENCE TO RELATED APPLICATIONS

The present disclosure is a US National Stage of International Application No. PCT/CN2020/139087, filed on Dec. 24, 2020, the entire contents of which are incorporated herein by reference.

### FIELD

The present disclosure relates to the field of license authentication, in particular to methods and apparatuses for license authentication, an electronic device, a system, and a storage medium.

### BACKGROUND

In the related art, software service providers generally provide users with software licenses indicating the license range, service life, etc. of software when providing software service, in order to protect a copyright of the software.

Before that, the providers will collect user information, environment information of devices of the users, etc. Such sensitive private information of the users is typically transmitted to the service providers in the form of plaintext, and is stored in the same form by the service providers obtaining the information. Stealing of the private user information will inescapably cause huge losses for the users.

### SUMMARY

The present disclosure provides methods and apparatuses for license authentication, an electronic device, a system, and a storage medium for solving the above technical problems in the related art.

In a first aspect, in order to solve the technical problems above, an embodiment of the present disclosure provides a method for license authentication applied to a licensing terminal. A solution of the method is as follows: obtaining registration information provided by a licensed terminal, where the registration information includes a public key and first environment ciphertext that are provided by the licensed terminal, the first environment ciphertext is obtained after the licensed terminal encrypts a currently obtained first environment fingerprint with a private key, and the first environment fingerprint includes software and hardware feature information of an environment where the licensed terminal is located; generating license information including the first environment ciphertext, encrypting the license information with the public key, and performing homomorphic encryption on encrypted license information to obtain license ciphertext, where the license information is configured to indicate a license range of a service to be licensed that requests license authentication in the licensed terminal; and sending the license ciphertext to the licensed terminal, causing the licensed terminal to verify the first environment ciphertext in the license ciphertext through a verification terminal to determine authenticity of the license ciphertext, and causing the licensed terminal to determine whether to perform license authentication on the service to be licensed in the licensed terminal according to received verification result ciphertext.

According to a possible implementation mode, before the sending the license ciphertext to the licensed terminal, the method further includes: receiving a license request sent by the licensed terminal, where the license request carries activation ciphertext of the service to be licensed, and the activation ciphertext is configured to identify activation of the service to be licensed; verifying whether the activation ciphertext is correct; and sending the license ciphertext to the licensed terminal in response to that the activation ciphertext is determined to be correct.

According to a possible implementation mode, an algorithm for the homomorphic encryption includes Paillier encryption or fully homomorphic encryption.

In a second aspect, an embodiment of the present disclosure provides a method for license authentication applied to a licensed terminal, and including: sending registration information carrying a public key and first environment ciphertext to a licensing terminal, where the first environment ciphertext is obtained after a currently obtained first environment fingerprint is encrypted with a private key, and the first environment fingerprint includes software and hardware feature information of an environment where the licensed terminal is located; receiving license ciphertext provided by the licensing terminal and generated based on the registration information, where the license ciphertext is obtained after the licensing terminal encrypts license information including the first environment ciphertext with the public key and performs homomorphic encryption on encrypted license information; generating a verification request including the license ciphertext, second environment ciphertext and the public key, where the second environment ciphertext is obtained after a currently obtained second environment fingerprint is encrypted with the public key, and the second environment fingerprint includes software and hardware feature information of an environment where the licensed terminal is located; sending the verification request to a verification terminal, causing the verification terminal to verify the first environment ciphertext in the license ciphertext through the second environment ciphertext to determine authenticity of the license ciphertext, and receiving verification result ciphertext sent by the verification terminal; and decrypting the verification result ciphertext with the public key to obtain a verification result, so as to determine whether to perform license authentication on a locally stored service to be licensed according to the verification result.

According to a possible implementation mode, the sending the registration information carrying the public key and the first environment ciphertext to the licensing terminal includes: generating a key pair including the public key and the private key with a specified key algorithm in a case that an authentication request of the service to be licensed is received, where the authentication request is generated based on an activation operation of a user on the service to be licensed; obtaining the first environment fingerprint, and encrypting the first environment fingerprint with the private key to obtain the first environment ciphertext; and sending the registration information carrying the public key and the first environment ciphertext to the licensing terminal.

According to a possible implementation mode, before the receiving license ciphertext provided by the licensing terminal and generated based on the registration information, the method further includes: sending a license request carrying activation ciphertext to the licensing terminal, and causing the licensing terminal to verify authenticity of the activation ciphertext, where the activation ciphertext is configured to identify activation of the service to be licensed; and receiving the license ciphertext sent by the licensing terminal after the licensing terminal passes verification.

In a third aspect, an embodiment of the present disclosure provides a method for license authentication applied to a verification terminal. The method includes: receiving a verification request sent by a licensed terminal, where the verification request is generated by the licensed terminal based on license ciphertext, second environment ciphertext and a public key, the license ciphertext is obtained after a licensing terminal encrypts license information including first environment ciphertext with the public key and performs homomorphic encryption on encrypted license information, the first environment ciphertext is obtained after the licensed terminal encrypts a currently obtained first environment fingerprint with a private key, the second environment ciphertext is obtained after a currently obtained second environment fingerprint is encrypted with the public key, and the first environment fingerprint includes software and hardware feature information of an environment where the licensed terminal is located; performing homomorphic decryption on the license ciphertext, obtaining the first environment ciphertext from license ciphertext subjected to homomorphic decryption, and verifying the first environment ciphertext with the second environment ciphertext to obtain verification result ciphertext; and sending the verification result ciphertext to the licensed terminal, and causing the licensed terminal to decrypt the verification result ciphertext with the public key to obtain a verification result, to determine whether to perform license authentication on a service to be licensed in the licensed terminal according to the verification result.

In a fourth aspect, an embodiment of the present disclosure provides an apparatus for license authentication applied to a licensing terminal. The apparatus includes: an obtaining element configured to obtain registration information provided by a licensed terminal, where the registration information includes a public key and first environment ciphertext that are provided by the licensed terminal, the first environment ciphertext is obtained after the licensed terminal encrypts a currently obtained first environment fingerprint with a private key, and the first environment fingerprint includes software and hardware feature information of an environment where the licensed terminal is located; an encryption element configured to generate license information including the first environment ciphertext, encrypt the license information with the public key, and perform homomorphic encryption on encrypted license information to obtain license ciphertext, where the license information is configured to indicate a license range of a service to be licensed that requests license authentication in the licensed terminal; and a receiving and sending element configured to send the license ciphertext to the licensed terminal, cause the licensed terminal to verify the first environment ciphertext in the license ciphertext through a verification terminal to determine authenticity of the license ciphertext, and cause the licensed terminal to determine whether to perform license authentication on the service to be licensed in the licensed terminal according to received verification result ciphertext.

According to a possible implementation mode, the receiving and sending element is further configured to: receive a license request sent by the licensed terminal, where the license request carries activation ciphertext of the service to be licensed; and verify whether the activation ciphertext is correct, where the activation ciphertext is configured to identify activation of the service to be licensed; and send the license ciphertext to the licensed terminal in response to that the activation ciphertext is determined to be correct.

According to a possible implementation mode, an algorithm for the homomorphic encryption includes Paillier encryption or fully homomorphic encryption.

In a fifth aspect, an embodiment of the present disclosure provides an apparatus for license authentication applied to a licensed terminal. The apparatus includes: a receiving and sending element configured to send registration information carrying a public key and first environment ciphertext to a licensing terminal, where the first environment ciphertext is obtained after a currently obtained first environment fingerprint is encrypted with a private key, and the first environment fingerprint includes software and hardware feature information of an environment where the licensed terminal is located; where a receiving and sending element is further configured to receive license ciphertext provided by the licensing terminal and generated based on the registration information, where the license ciphertext is obtained after the licensing terminal encrypts license information including the first environment ciphertext with the public key and performs homomorphic encryption on encrypted license information; a generation element configured to generate a verification request including the license ciphertext, second environment ciphertext and the public key, where the second environment ciphertext is obtained after a currently obtained second environment fingerprint is encrypted with the public key, and the second environment fingerprint includes software and hardware feature information of an environment where the licensed terminal is located; where the receiving and sending element is further configured to send the verification request to a verification terminal, cause the verification terminal to verify the first environment ciphertext in the license ciphertext through the second environment ciphertext to determine authenticity of the license ciphertext, and receive verification result ciphertext sent by the verification terminal; and a processing element configured to decrypt the verification result ciphertext with the public key to obtain a verification result, to determine whether to perform license authentication on a locally stored service to be licensed according to the verification result.

According to a possible implementation mode, the receiving and sending element is further configured to: generate a key pair including the public key and the private key with a specified key algorithm in response to that an authentication request of the service to be licensed is received, where the authentication request is generated based on an activation operation of a user on the service to be licensed; obtain the first environment fingerprint, and encrypt the first environment fingerprint with the private key to obtain the first environment ciphertext; and send the registration information carrying the public key and the first environment ciphertext to the licensing terminal.

According to a possible implementation mode, the receiving and sending element is further configured to: send a license request carrying activation ciphertext to the licensing terminal, and cause the licensing terminal to verify authenticity of the activation ciphertext, where the activation ciphertext is configured to identify activation of the service to be licensed; and receive the license ciphertext sent by the licensing terminal after the licensing terminal passes verification.

In a sixth aspect, an embodiment of the present disclosure provides an apparatus for license authentication applied to a verification terminal, and the apparatus includes: a receiving element configured to receive a verification request sent by a licensed terminal, where the verification request is generated by the licensed terminal based on license ciphertext, second environment ciphertext and a public key, the license ciphertext is obtained after a licensing terminal encrypts license information including first environment ciphertext with the public key and performs homomorphic encryption on encrypted license information, the first environment ciphertext is obtained after the licensed terminal encrypts a currently obtained first environment fingerprint with a private key, the second environment ciphertext is obtained after a currently obtained second environment fingerprint is encrypted with the public key, and the first environment fingerprint includes software and hardware feature information of an environment where the licensed terminal is located; a verification element configured to perform homomorphic decryption on the license ciphertext, obtain the first environment ciphertext from license ciphertext subjected to homomorphic decryption, and verify the first environment ciphertext with the second environment ciphertext to obtain verification result ciphertext; and a sending element configured to send the verification result ciphertext to the licensed terminal, and cause the licensed terminal to decrypt the verification result ciphertext with the public key to obtain a verification result, so as to perform license authentication on a service to be licensed in the licensed terminal.

In a seventh aspect, an embodiment of the present disclosure provides a server applied to a licensing terminal. The server includes the apparatus according to the fourth aspect.

In an eighth aspect, an embodiment of the present disclosure provides an electronic device. The electronic device includes the apparatus according to the fifth aspect and the sixth aspect.

In a ninth aspect, an embodiment of the present disclosure further provides an apparatus for license authentication. The apparatus includes: at least one processor, and a memory connected to the at least one processor, where the memory stores instructions executable by the at least one processor, and the at least one processor executes the method according to the first aspect, the second aspect or the third aspect by executing the instructions stored in the memory.

In a tenth aspect, an embodiment of the present disclosure further provides a readable storage medium. The readable storage medium includes: a memory, where the memory is configured to store instructions, and when the instructions are executed by a processor, an apparatus including the readable storage medium implements the method according to the first aspect, the second aspect or the third aspect.

### BRIEF DESCRIPTION OF THE DRAWINGS

FIG. 1 is a flowchart of a method for license authentication applied to a licensing terminal according to an embodiment of the present disclosure.

FIG. 2 is a flowchart of a method for license authentication applied to a licensed terminal according to an embodiment of the present disclosure.

FIG. 3 is a flowchart of a method for license authentication applied to a verification terminal according to an embodiment of the present disclosure.

FIG. 4 is a flowchart of license authentication interaction according to an embodiment of the present disclosure.

FIG. 5 is a schematic structural diagram of an apparatus for license authentication applied to a licensing terminal according to an embodiment of the present disclosure.

FIG. 6 is a schematic structural diagram of an apparatus for license authentication applied to a licensed terminal according to an embodiment of the present disclosure.

FIG. 7 is a schematic structural diagram of an apparatus for license authentication applied to a verification terminal according to an embodiment of the present disclosure.

### DETAILED DESCRIPTION OF THE EMBODIMENTS

Embodiments of the present disclosure provide methods and apparatuses for license authentication, an electronic device, a system, and a storage medium for solving the above technical problems in the related art.

As used in the present disclosure, the term “homomorphism” refers to property of some cryptosystems that cause a computerized system to perform operations by using encrypted ciphertext data. The encrypted ciphertext data are decrypted to produce plaintext results, and the plaintext results match results if the same operation is applied to plaintext data. Through a cryptosystem with addition homomorphism, a computer may add ciphertext a and ciphertext b together to produce result ciphertext c. When the result ciphertext c is decrypted, a plaintext value is generated. The plaintext value matches the sum of plaintext data encrypted with a and b. For example, if a and b are ciphertext that encrypts values 2 and 3 respectively, the result ciphertext c produces a value of 5 (2+3=5) when decrypted. A computer receiving the original ciphertext a and b may generate ciphertext c through direct addition of the original ciphertext without decrypting either of original encrypted inputs a and b or requiring access to any cryptographic key.

Homomorphism of the cryptosystem: in a cryptographic system, if a ciphertext operation (such as addition and multiplication) in a ciphertext space may be mapped into a plaintext space, then the cryptographic system is deemed to have homomorphism. Encryption with a homomorphic cryptosystem is deemed homomorphic encryption.

A key in an asymmetric cryptosystem includes a public key and a private key, and homomorphism of the asymmetric cryptosystem is widely used, such as Rivest-Shamir-Adleman (RSA) algorithm and Paillier algorithm.

In other words, homomorphic encryption (HE) is a cryptographic technology based on a computational complexity theory of mathematical problems. Data subjected to homomorphic encryption are processed to obtain an output, the output is decrypted, and a result is the same as an output result obtained by processing unencrypted original data in the same way. Based on the property, encrypted data may be processed by others without revealing any original content during processing. At the same time, after a user owning the key decrypts the processed data, a result obtained is exactly a processed result.

A homomorphic encryption technology may have two types, somewhat homomorphic encryption (SWHE) and fully homomorphic encryption (FHE).

FHE may complete computation of an arbitrary complexity function in the ciphertext space, but has high computation cost, poor performance and complex principles, such as the typical Brakerski-Gentry-Vaikuntanathan (BGV) algorithm. The SWHE merely supports some specific operation functions. The SWHE scheme is less powerful, but low in computational overhead, is easier to implement, and may be used in practice now.

Mathematical meaning of homomorphism: an encryption function (defined as E) is assumed to satisfy:

E(a)+E(b)=E(a+b);

E(a)*E(b)=E(a*b);

if the above two equations are satisfied, the encryption function is deemed to have full homomorphism, and if one of the above two equations is satisfied, the encryption function is deemed to have somewhat homomorphism.

In the case of an operation function F,

if F(a)=x D(x)=a;

Entire encryption E and decryption D are fully homomorphic encryption.

In order to better understand the above technical solution, technical solutions of the present disclosure will be described below in detail through accompanying drawings and specific embodiments. It should be understood that embodiments of the present disclosure and specific features in the embodiments are detailed descriptions of the technical solutions of the present disclosure, rather than limitation to the technical solutions of the present disclosure. In case of no conflict, the embodiments of the present disclosure and the technical features in the embodiments may be combined with one another.

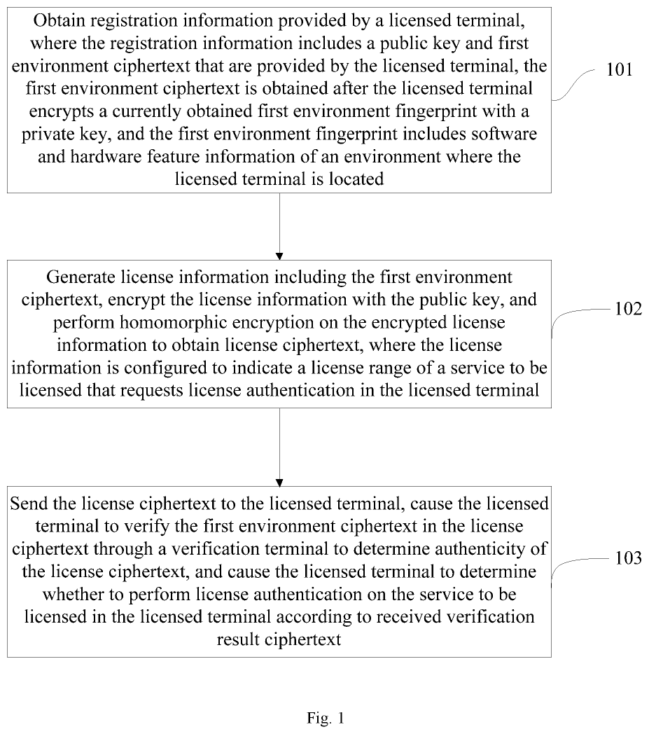

With reference to FIG. 1, the embodiment of the present disclosure provides a method for license authentication applied to a licensing terminal. The method includes the following operations.

S101: registration information provided by a licensed terminal is obtained. The registration information includes a public key and first environment ciphertext that are provided by the licensed terminal, the first environment ciphertext is obtained after the licensed terminal encrypts a currently obtained first environment fingerprint with a private key, and the first environment fingerprint includes software and hardware feature information of an environment where the licensed terminal is located.

The licensing terminal may be a server, the licensed terminal may be a piece of software in an electronic device, and the software may be application software, such as instant messaging software, play software, office software, advertising machine software, etc. The software may also be an operation system, such as a windows system, OS system, android system, and an operating system of an advertising machine.

When a user needs to use some service in a licensed terminal, and the service is deemed a service to be licensed before the service is licensed. The licensed terminal may generate a key pair including a public key and a private key by using a specified key algorithm, and encrypt an obtained first environment fingerprint with the private key to obtain first environment ciphertext, then generate registration information including the public key and the first environment ciphertext, and send the registration information to the licensed terminal. The first environment fingerprint includes software and hardware feature information of an environment where the licensed terminal is located.

For example, the licensed terminal is a video play application in the electronic device, and the user is currently an ordinary user of the video play application. The user hopes to become a very important person (VIP) of the video play application later. In this case, according to an operation of the user, an authentication request for providing a VIP service (that is, the service to be licensed) is generated, and the video play application generates a key pair including a public key and a private key with a specified key algorithm, obtains a first environment fingerprint, encrypts the first environment fingerprint with the private key to obtain first environment ciphertext, generates registration information according to the first environment ciphertext and the public key, and sends the registration information to the server (that is, the licensing terminal).

The registration information may also include purchase information corresponding to the service to be licensed, such as contents of a purchased service, a time limit corresponding to the purchased service, and a level corresponding to the service. In the case that the service to be licensed is the VIP service, a level of the VIP service may be divided into gold VIP, diamond VIP and super VIP, and effective time may be divided into 1 month, 3 months, 6 months, 1 year, lifetime, etc., all of which may be used as purchase information. It is certain that according to different types of the licensed terminal and the service to be licensed, the registration information may not include the above purchase information, such as registration information of some portable applications as well as government and enterprise service software (such as social security software and browsers). That is, the contents included in the registration information may be set freely according to actual requirements.

It should be noted that the service to be licensed may also be specific multimedia information, including a video, a picture, etc. If the licensed terminal is play software, a service to be licensed may be a separate video resource (such as a newly released movie, cloud exhibition, live broadcast and music requiring separate payment). If the terminal to be licensed is an operation system, a service to be licensed may be understood as a service that applies for a license of the operation system.

The licensed terminal may send the registration information to the licensing terminal offline or online or in other safe modes.

After receiving the registration information sent by the licensed terminal, the licensing terminal may execute S102 and S103.

S102: license information including the first environment ciphertext is generated, the license information is encrypted with the public key, and homomorphic encryption is performed on encrypted license information to obtain license ciphertext, where the license information is configured to indicate a license range of a service to be licensed that requests license authentication in the licensed terminal.

S103: the license ciphertext is sent to the licensed terminal, the licensed terminal is caused to verify the first environment ciphertext in the license ciphertext through a verification terminal to determine authenticity of the license ciphertext, and the licensed terminal is caused to determine whether to perform license authentication on the service to be licensed in the licensed terminal according to received verification result ciphertext.

Due to introduction of random noise in homomorphic encryption, a reverse engineering theory of an encryption result is possible, thereby guaranteeing security of a transmission link to the maximum extent.

In the present disclosure, the verification terminal may be understood as a verification program, a verification plug-in, or an electronic device on which the verification program and the verification plug-in are mounted. The electronic device may be, for example, a mobile phone, a tablet computer, an advertising machine, a router, a smart speaker, a wearable device, etc. The licensed terminal and the licensing terminal may be located in the same electronic device.

After receiving the registration information, the licensing terminal may generate the license information including the first environment ciphertext according to contents of the registration information, the license information may indicate a license range of the service to be licensed, and the license range may include, for example, duration of a license, specific contents of the service, a type of devices allowed to be used, the maximum number of devices, etc.

For example, the licensed terminal as the video play software and the service to be licensed as the VIP service are still taken as an example, the license information further includes effective time of the VIP service (for example, 1 year) besides the first environment ciphertext, and the service scope includes all series available to be freely watched, but excludes newly released movies or other movies that need to be paid separately, or includes all series and movies available to be freely watched, but excludes other movies that need to be paid separately.

For example again, the licensed terminal is an advertising machine software, a service to be licensed is a broadcasting service of an advertisement, a license range may be broadcasting time of the advertisement (such as broadcasting at 12 o'clock), broadcasting duration is 30 s without interruption, etc.

The licensing terminal may generate license information according to first environment ciphertext information and attribute information of software (that is, a terminal to be licensed) corresponding to the service to be licensed, such as a product identifier (product ID), a product series, a product type, a product name and a product version (see Table 1), and a license range of the service to be licensed, etc., and encrypt license information with a public key to obtain encrypted license information, and simultaneously perform homomorphic encryption on the encrypted license information to obtain license ciphertext.

TABLE 1

| Attribute key | Attribute value |
|---|---|
| License ID | License 01 |
| Product ID | sku-001-1001 |
| Product type | retail-order-promising |
| . . . | . . . |

A formula for homomorphic encryption may be expressed as follows:

C1=HE(PK,Data);

where PK represents a public key provided by the licensed terminal, Data represent license information, and HE represents an algorithm for homomorphic encryption, that is, the license information (Data) is encrypted with the public key (PK), homomorphic encryption is performed on encrypted license information to obtain a homomorphic encryption result (C1), and the homomorphic encryption result is the license ciphertext according to the present disclosure.

The algorithm for homomorphic encryption may include a pailler encryption algorithm and a fully homomorphic encryption algorithm (such as IBM the-toolkit-linux).

For some applications (such as an operation system or a tool application), in order to obtain a license of the service to be licensed (in the present disclosure, the license is transmitted in the form of ciphertext, that is, license ciphertext), the licensed terminal may further need to provide an activation code for the licensing terminal (in the present disclosure, the activation code is transmitted in the form of ciphertext, that is, activation ciphertext).

After the licensing terminal receives a license request sent by the licensed terminal, whether the activation ciphertext is correct is verified, where the license request carries activation ciphertext of the service to be licensed; and in response to that the activation ciphertext is determined correct, the license ciphertext is sent to the licensed terminal, where the activation ciphertext is configured to identify activation of the service to be licensed.

For example, in the case that the licensed terminal is an operation system, when the system is initialized after the system is mounted and restarted, a dialog box requiring the user to input the activation code pops up. The operation system obtains the activation code based on the operation of the user and encrypts the activation code to obtain the activation ciphertext, then generates a license request according to the activation ciphertext and sends the license request to the server (the licensing terminal). A sending mode may be offline or online. The licensing terminal may determine authenticity of the activation ciphertext by performing verification computation (for example, by comparing with activation ciphertext stored locally in the licensing terminal, or obtaining a result by computing the activation ciphertext with an algorithm) on the activation ciphertext. When the licensing terminal determines the activation ciphertext to be correct, the license ciphertext is sent to the licensed terminal, and the licensed terminal may be caused to verify authenticity (a verification process of the verification terminal is introduced in detail in a subsequent method corresponding to the verification terminal) of the license ciphertext through the verification terminal, so as to determine whether to perform license authentication on the service to be licensed in the licensed terminal according to a verification result. If the verification result is passed, the licensed terminal may perform license authentication on the service to be licensed, otherwise, license authentication on the service to be licensed may be abandoned.

After receiving the license ciphertext, the licensing terminal may generate a license request, the license request carries the license ciphertext and second environment ciphertext, and the second environment ciphertext is obtained after a newly acquired second environment fingerprint is encrypted with a public key. The licensing terminal sends the license request to the verification terminal to verify a first environment fingerprint in the license ciphertext, so as to determine authenticity of the license ciphertext by, such as verifying whether the first environment fingerprint is true. The licensing terminal verifies the authenticity of the first environment ciphertext by performing a homomorphic operation on the first environment ciphertext and the second environment ciphertext in an encrypted environment, so as to determine whether the private key and the public key match for determining authenticity of the first environment ciphertext.

The licensing terminal may generate license information including the first environment ciphertext merely by obtaining the public key and the first environment ciphertext provided by the licensed terminal, perform homomorphic encryption on the license information with the public key, and cause the licensing terminal to generate the license ciphertext without obtaining the first environment fingerprint in the first environment ciphertext. Therefore, no one may abuse beyond authority or pry into private information (the first environment fingerprint) of the licensed terminal at the licensing terminal, thereby improving security of the private information of the licensed terminal. Besides, since the license ciphertext is obtained through homomorphic encryption, computation complexity of the licensed terminal is reduced, the license information is prevented from being maliciously cracked in a transmission process, and security of the license information is improved.

The method for license authentication has been introduced from the side of the licensing terminal, and a method for license authentication used in the licensed terminal will be introduced below from the side of the licensed terminal.

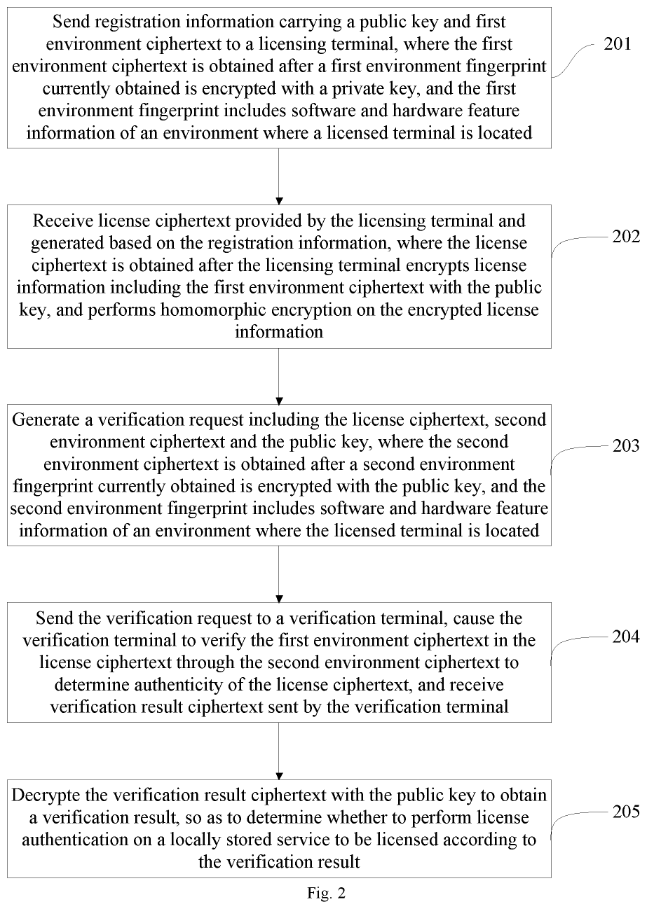

With reference to FIG. 2, based on the same inventive concept, an embodiment of the present disclosure provides a method for license authentication applied to the licensed terminal. The method includes the following operations.

S201: registration information carrying a public key and first environment ciphertext is sent to a licensing terminal, where the first environment ciphertext is obtained after a currently obtained first environment fingerprint is encrypted with a private key, and the first environment fingerprint includes software and hardware feature information of an environment where a licensed terminal is located.

For example, the licensed terminal is an instant messaging application in an electronic device, and a user is currently an ordinary user of the instant messaging application. The user hopes to become a very important person (VIP) of the instant messaging application later. In this case, according to an operation of the user, an authentication request for providing a VIP service (that is, a service to be licensed) is generated, and the instant messaging application generates a key pair including a public key and a private key with a specified key algorithm, obtains a first environment fingerprint, encrypts the first environment fingerprint with the private key to obtain first environment ciphertext, generates registration information according to the first environment ciphertext and the public key, and sends the registration information to the server (that is, the licensing terminal).

The registration information may also include purchase information corresponding to the service to be licensed, such as contents of a purchased service, a time limit corresponding to the purchased service, and a level corresponding to the service. In the case that the service to be licensed is the VIP service, a level of the VIP service may be divided into gold VIP, platinum VIP, and diamond VIP, and effective time may be divided into 3 months, 6 months, 1 year, etc., all of which may be used as purchase information. It is certain that according to different types of the licensed terminal and the service to be licensed, the registration information may not include the above purchase information, such as registration information of some portable applications as well as government and enterprise service software (such as tax software, financial software or shopping software). That is, the contents included in the registration information may be set freely according to actual requirements.

It should be noted that the service to be licensed may also be specific multimedia information, including a video, a picture, etc. If the licensed terminal is play software, a service to be licensed may be a separate video resource (such as a newly released movie, cloud exhibition and live broadcast requiring separate payment). If the terminal to be licensed is an operation system, a service to be licensed may be understood as a service that applies for a license of the operation system, or some application in the operation system.

The registration information carrying the public key and the first environment ciphertext may be sent to the licensing terminal in a mode as follows.

When the authentication request of the service to be licensed is received, a key pair including a public key and a private key is generated with a specified key algorithm; the first environment fingerprint is obtained, and the first environment fingerprint is encrypted with the private key to obtain the first environment ciphertext; and the registration information carrying the public key and the first environment ciphertext is sent to the licensing terminal.

The specified key algorithm may be an asymmetric key production algorithm and related bit requirements selected by the user and an enterprise according to their own internal policies and security strategies, such as classic RSA algorithm, elliptic curve cryptography (ECC), elliptic curve digital signature algorithm (ECDSA), and state cryptographic algorithm SM2.

For example, an example of a typical RSA 2048-bit public and private-key key pair privacy enhanced mail (PEM) format is as following.

Public key:

----BEGIN PUBLIC KEY-----
MIIBIjANBgkqhkiG9w0BAQEFAAOCAQ8AMIIBCgKCAQEAzB5DdsN4x+HdgSxYg
Fkx
tITcIlAyivoGaoRkQMCAtJORhxtu5HZI5x4t67nJSh6uq8YVzdqYulu2Zzx5UMrm
jjSjICXcZ3Kn/I+We45+IKDswkMrDq3p6nfsoQvLH9hNPsnkWz7+fiDvQGWECtko
aRBxB4u5AR63vLgf6o1AcePPX97VaHMF1l8ESqBcirgiZBTTNizSB4kVGk+akkjk
lOEzARWnoBYHItl8Jq5Uwh2Bk2EhHI6FOyuz9rRDgJGhh4SYgpRfsvuOfUgCCDoF
jAiKPEdtL+KIR1zizxrP9ZWOzWSU7ypNCmfkqc7kswzKwGIW1iUu6KczYovz62k+
BQIDAQAB-----END PUBLIC KEY-----

Private key:

----BEGIN PRIVATE KEY-----
MIIEwAIBADANBgkqhkiG9w0BAQEFAASCBKowggSmAgEAAoIBAQDMHkN2w3j
H4d2B
LFiAWTG0hNwiUDKK+gZqhGRAwIC0k5GHG27kdkjnHi3ruclKHq6rxhXN2pi6W7Zn
PHlQyuaONKMgJdxncqf8j5Z7jn4goOzCQysOrenqd+yhC8sf2E0+yeRbPv5+IO9A
ZYQK2ShpEHEHi7kBHre8uB/
qjUBx489f3tVocwXWXwRKoFyKuCJkFNM2LNIHiRUa
T5qSSOSU4TMBFaegFgci2XwmrlTCHYGTYSEcjoU7K7P2tEOAkaGHhJiClF+y+459
SAIIOgWMCIo8R20v4ohHXOLPGs/1lY7NZJTvKk0KZ+SpzuSzDMrAYhbWJS7opzNi
i/PraT4FAgMBAAECggEBAK4Buqd7GfLkBI3C/StlXi8y9+q0jXHWlTOm60QcF1xZ
VL1l0JIomBuWqbUDq6ppH6TF9/6GNJ7h4kx9zDnozsU58DpOrGbv4m83BSUNo04z
gcJVulYIQpokY/AieqYKIke9mtOCjzd84hj2sasB1yZB4ul43l0rD51tJaAxjFfJ
Q9Z3J6zwpZA0ePgp/DHG50KzZNXZcRL+qPAenE7iXBn2vfDh88GKFm1pekQ203jJ
Of/MXXnFEUcRVn95jB9TcL/BnmglnEJkzKLM/7HSHS89R9EjTAcHzL+crjb/cWKx
PPAC3Gco2zWfr/ w4rup6DGYqkoD8B7hFDEktC0ENX10CgYEA8Ietek7mCSq0RzVL
NA41GHtJSa6GHeS/
FNzpw8FBbcDh1HV2QtA6nd9gxPX4m3c6IM5LStBZnQwAONQ4
RETj8hw9zu5b1UTWDISnHhEtguUAaDjI+sTrgkwXV3OvMxACCuV0UJ/YV8r64TRP
SNh+1HF5ewJmmEfrPBAK9c3NA58CgYEA2T8RDj9iUNO0oXM3axpMNDfX4QsPsw
eT
sGWc4L+TyIkVsHwuaKr4tHtXlDdV0PmPoGI6dy0fm+LkgWnBP7RbHCljXGa3KXVQ
DrDXdisfC406QbhefYOorvNvKQQ7mp0/ rpZrIXG2alHF8hRNsLTTRuAKA5nemJZw
cMtCodleu9sCgYEArffkIEd6l/y8IZjJSOBRxOA+1L0XIf31urhBl6VqlmBgtlMy
8wY6rz8Gdc7WPlPQxjOPP5BMkItCidfszmvpVo7YoZfC8hD0pF85pESWX0sUrU0N
CFtvX3F7nHP+rvcQEyN8qmfCiVU1ebdk9PIpYaylSbQl0lSKLooH81sjwk8CgYEA
u65aY76qhz1+bYSGOgcMEoiz/f16YKaJFvmSIDAh0jtr+34s8cvS9MkiDjAH+XPA
e0ShUdgv2JKZ6puckhaUJ64x4t/ yGOT6dtacLcBvH6Gw1JodN74IeqxgOkUn4Rk8
rO3SO6BrgUqIAe08eQ6fADoJLLc/ sP82wJs5Q23xA8UCgYEA10cRaeoksBFTME7i
qiC61ESgbgsOoqvOyGCvoOWTJqV0telwP0LLxk12D29995SKnPWpSipb6C8ARWsZ
Df3QFM77+slAW+pDqrzv6sDvyDvpalMaIDi5bTS+fqdn7DLkGl6PzoYcOljlGViP
0RFwybAnyj/ulI47NoL3jZKq+hI=
-----END PRIVATE KEY-----

An environment fingerprint of a licensed terminal includes: Software development kit (SDK) fingerprint: the fingerprint is generated according to features of the SDK, such as Android ID generation of Android.

Container fingerprint: SDK may run in a container such as Docker, and the container fingerprint may be ID of the container or a process ID of Daemon.

System fingerprint: a fingerprint of an operation system, such as machine id of Linux system, a system activation code and registry information of Windows system, etc.

Hardware fingerprint: hardware information, such as a serial number of central processing unit (CPU), a hard disk, a motherboard, a graphics processing unit (GPU), or information on a read-only memory (ROM) of a chip.

External fingerprint: information on an external device, such as a dongle and a hardware lock.

Multi-factor fingerprint: software, hardware, a system and other factors are comprehensively considered to generate relevant fused fingerprints.

The above information represents the software and hardware feature information of the environment where the licensed terminal is located. Specifically, one or more fingerprints used as the environment fingerprint may be preset by the user, and the fingerprint may be obtained according to a preset mode when the first environment fingerprint information is obtained.

After the key pair and the first environment fingerprint are obtained in the above mode, the first environment fingerprint may be encrypted with the private key to obtain the first environment ciphertext, and the first environment ciphertext and the public key are carried in the registration information and sent to the licensing terminal. The registration information may be sent to the licensing terminal offline or in other safe modes.

Since the private information (the first environment fingerprint) of the licensed terminal is transmitted to the licensing terminal in the form of ciphertext (the first environment ciphertext), and the licensing terminal may not decrypt the first environment ciphertext, such that the private information of the licensed terminal may be prevented from leaking during transmission or at the licensed terminal, a threat to security of the licensed terminal through malicious use of the private information of the licensed terminal is avoided, and a technical effect of improving the security of the licensed terminal is achieved.

After the registration information is sent to the licensing terminal, S202 may be executed.

S202: license ciphertext provided by the licensing terminal and generated based on the registration information is received, where the license ciphertext is obtained after the licensing terminal encrypts license information including the first environment ciphertext with the public key, and perform homomorphic encryption on encrypted license information.

For some applications (such as an operation system or a tool application), in order to obtain a license of the service to be licensed (in the present disclosure, the license is transmitted in the form of ciphertext, that is, license ciphertext), the licensed terminal may further need to provide an activation code for the licensing terminal (in the present disclosure, the activation code is transmitted in the form of ciphertext, that is, activation ciphertext).

Before the license ciphertext sent by the licensing terminal is received, if the licensed terminal is a Chinese character recognition application, the user is required to input an activation code when mounting the Chinese character recognition application, and the Chinese character recognition application generates corresponding activation ciphertext according to the activation code; alternatively, the Chinese character recognition application needs to reboot a system after being mounted. When the system is initialized during rebooting, a dialog box of the Chinese character recognition application is provided requiring the user to input the activation code, such that the Chinese character recognition application may generate corresponding activation ciphertext according to the activation code. The licensed terminal (Chinese character recognition application) may send a license request carrying the activation ciphertext to a licensing terminal, such that the licensing terminal may verify authenticity of the activation ciphertext (for example, by comparing with activation ciphertext stored locally in the licensing terminal, or obtaining a result by computing the activation ciphertext with an algorithm). The activation ciphertext is used for identifying activation of the service to be licensed. The license ciphertext sent by the licensing terminal is received after the licensing terminal passes verification.

The licensed terminal may receive the license ciphertext offline or online.

After the license ciphertext is received, S203 may be executed.

S203: a verification request including the license ciphertext, second environment ciphertext and the public key is generated, where the second environment ciphertext is obtained after a currently obtained second environment fingerprint is encrypted with the public key, and the second environment fingerprint includes software and hardware feature information of an environment where the licensed terminal is located.

After receiving the license ciphertext, the licensed terminal obtains a current second environment fingerprint in the same way as the first environment fingerprint, encrypts the second environment fingerprint with the public key to obtain the second environment ciphertext, and generates the verification request including the license ciphertext, the second environment ciphertext and the public key.

After the verification request is generated, S204 and S205 may be executed.

S204: the verification request is sent to a verification terminal, the verification terminal is caused to verify the first environment ciphertext in the license ciphertext through the second environment ciphertext to determine authenticity of the license ciphertext, and verification result ciphertext sent by the verification terminal is received. Reference may be made to description of a subsequent method corresponding to the verification terminal for a verification process of the license ciphertext of the verification terminal.

S205: the verification result ciphertext is decrypted with the public key to obtain a verification result, so as to determine whether to perform license authentication on a locally stored service to be licensed according to the verification result.

The licensed terminal sends the verification request to the verification terminal to verify the authenticity of the license ciphertext (with reference to the introduction in the verification terminal for a specific verification process), and the licensed terminal receives the verification result ciphertext sent by the verification terminal, and decrypts the verification result ciphertext with the public key to obtain the verification result. In the case that the verification result indicates that the license ciphertext is true, the licensed terminal performs license authentication on the service to be licensed according to the license information. In the case that the verification result indicates that the license ciphertext is false, the licensed terminal discards the license ciphertext, and resends a license request to the licensing terminal, and repeats the verification process.

The licensed terminal encrypts the first environment fingerprint and sends encrypted first environment fingerprint to the licensing terminal, such that the licensing terminal may perform homomorphic encryption on the license information including the first environment ciphertext with the public key provided by the licensed terminal, and receive the license ciphertext, and the verification terminal may verify the first environment ciphertext in the license ciphertext through the second environment ciphertext to determine the authenticity of the license ciphertext. Neither the licensing terminal nor the licensed terminal may obtain the private information (the first environment fingerprint) of the licensed terminal during the entire process, such that the user of the licensed terminal may flexibly reuse their own security key systems and strategies. The private key is saved by the licensed terminal, thus improving security of the licensed terminal. Moreover, according to the method, more security controllability is put forwards in the verification terminal and the licensed terminal as far as possible, which is naturally friendly to level protection rules and reduces cost of product level protection evaluation.

The method for license authentication has been introduced from the side of the licensing terminal and the side of the licensed terminal, and a method for license authentication used in the verification terminal will be introduced below from the side of the verification terminal.

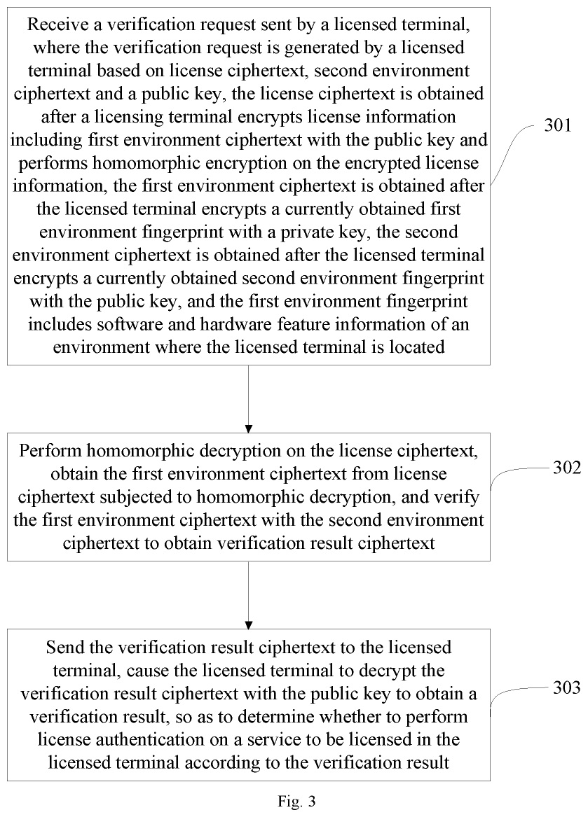

With reference to FIG. 3, based on the same inventive concept, an embodiment of the present disclosure provides a method for license authentication applied to the verification terminal. The method includes: S301: a verification request sent by a licensed terminal is received, where the verification request is generated by a licensed terminal based on license ciphertext, second environment ciphertext and a public key, the license ciphertext is obtained after a licensing terminal encrypts license information including first environment ciphertext with the public key and performs homomorphic encryption on encrypted license information, the first environment ciphertext is obtained after the licensed terminal encrypts a currently obtained first environment fingerprint with a private key, the second environment ciphertext is obtained after a currently obtained second environment fingerprint is encrypted with the public key, and the first environment fingerprint includes software and hardware feature information of an environment where the licensed terminal is located.

The first environment fingerprint and the second environment fingerprint each include the software and hardware feature information of the environment where the licensed terminal is located, with difference in time when the software and hardware feature information is obtained.

Reference may be made to relevant description of the licensed terminal for generation modes of the verification request and the first environment ciphertext, and reference may be made to relevant description of the licensing terminal for a generation mode of the license ciphertext, which will not be repeated herein.

S302: homomorphic decryption is performed on the license ciphertext, the first environment ciphertext is obtained from license ciphertext subjected to homomorphic decryption, and the first environment ciphertext is verified with the second environment ciphertext to obtain verification result ciphertext.

In the present disclosure, the verification terminal may be understood as a verification program, a verification plug-in, or an electronic device on which the verification program and the verification plug-in are mounted. The electronic device may be, for example, a mobile phone, a tablet computer, an advertising machine, a router, etc. The licensed terminal and the licensing terminal may be located in the same electronic device.

The homomorphic decryption on the license ciphertext by the verification terminal means that the license ciphertext is decrypted in an encrypted environment, which makes it impossible for the verification terminal to actually get specific contents of the license ciphertext.

Then, the first environment ciphertext is obtained from the license ciphertext subjected to homomorphic decryption, and verifying the first environment ciphertext with the second environment ciphertext may be implemented through a homomorphic operation on the first environment ciphertext and the second environment ciphertext, so as to determine whether a public key and a private key used by the first environment ciphertext and the second environment ciphertext match, and then determine the authenticity of the first environment ciphertext. If the public key and the private key above match, the first environment ciphertext is determined to be true, indicating correspondingly no tampering with the license ciphertext, that is, the license ciphertext is true; otherwise, the license ciphertext is false. In this way, the verification result in the encrypted environment may be obtained (since the verification result is obtained by the verification terminal in the encrypted environment, the verification terminal also outputs the verification result in the form of ciphertext, that is, the verification result ciphertext according to the present disclosure). The verification process may be deemed homomorphic verification.

S303: the verification result ciphertext is sent to the licensed terminal, and the licensed terminal is caused to decrypt the verification result ciphertext with the public key to obtain a verification result, so as to determine whether to perform license authentication on a service to be licensed in the licensed terminal according to the verification result.

After the verification terminal sends the verification result ciphertext to the licensed terminal, the licensed terminal decrypts the verification result ciphertext with the public key to obtain a decryption result, and then determines the authenticity of the license ciphertext. If the license ciphertext is true, license information obtained after the license ciphertext is decrypted is used to perform license authentication on the service to be licensed. If the license ciphertext is determined false according to the decryption result, the license ciphertext is discarded and an application is made again to the licensing terminal for new license ciphertext.

When the verification terminal performs homomorphic verification on the license ciphertext, the entire verification process is free of decryption, all verification operations are performed on the ciphertext, and results are also returned in the form of ciphertext, such that the private information (the environment fingerprint) of the licensed terminal and the license information of the licensed terminal may not be obtained at the verification terminal, thus improving the security of the licensed terminal and the license ciphertext. Since the entire verification process does not need decryption, complexity of multi-dimensional multi-round encryption and decryption is greatly reduced, and verification efficiency is improved.

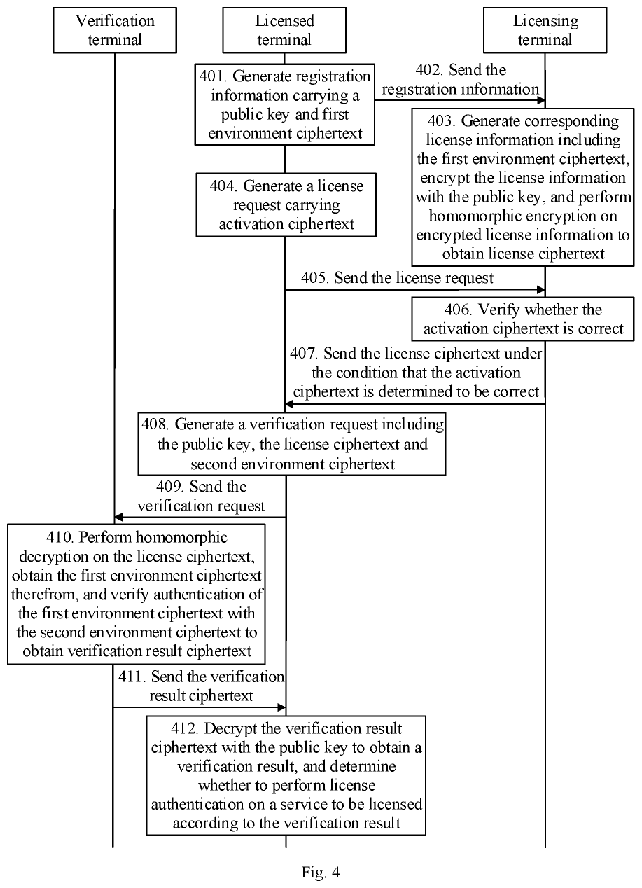

In order to make those skilled in the art fully understand the above technical solution, reference may be made to FIG. 4, a flowchart of license authentication interaction according to an embodiment of the present disclosure is shown. For example, the licensed terminal is a video application, the service to be licensed is watching of a newly released movie A, the licensing terminal is a server, and the verification terminal is a verification application.

S401: the licensed terminal generates registration information carrying a public key and first environment ciphertext.

The user finds the newly released movie A (the service to be licensed) when using the video application (the licensed terminal). The user wants to watch the movie A, and performs a purchase operation on the movie in the video application. According to the purchase operation, an authentication request for the movie A is generated to request activation of the movie A. According to the authentication request, the video application generates a key pair including a public key and a private key with a specified key algorithm, and stores the key pair locally. Besides, a first environment fingerprint of an environment where the video application is located is obtained, and the first environment fingerprint is encrypted with the private key to obtain first environment ciphertext, and the registration information is generated according to the first environment ciphertext and the public key.

S402: the licensed terminal sends the registration information to the licensing terminal. That is, the video application sends the registration information to the server.

S403: the licensing terminal generates corresponding license information including the first environment ciphertext, encrypts the license information with the public key and performs homomorphic encryption on encrypted license information to obtain license ciphertext.

After receiving the registration information, the server (the licensing terminal) obtains the first environment ciphertext and the public key therefrom, and generates the license information including the first environment ciphertext based on attributes and a purchase scope of the video application (these are also carried in the registration information, or the attributes of the video application are not necessary to carry when the video application corresponds to the server). In the license information, it is determined that a license range is movie A, movie A may be viewed once or unlimitedly, in a screen mirroring mode, or limited to view on a mobile phone, a tablet computer and a desktop computer.

Then the server (the licensing terminal) encrypts the license information with the public key, and performs the homomorphic encryption on the encrypted license information to obtain the license ciphertext.

It should be noted that in this embodiment, the server may directly send the license ciphertext to the video application without actually executing steps 404-407, but in order to show a solution that the activation ciphertext may be used, it is assumed that the video application needs to use the activation ciphertext to obtain the license ciphertext.

S404: the licensed terminal generates a license request carrying the activation ciphertext.

It should be noted that an order of S403 and S404 may also be interchanged, that is, S404 may be executed before S403.

It is assumed that the server sends an activation code corresponding to the license ciphertext to a mobile phone of the user after generating the license ciphertext, the video application obtains the activation code input by the user, encrypts the activation code to obtain the activation ciphertext, and generates the license request carrying the activation ciphertext.

S405: the licensed terminal sends the license request to the licensing terminal.

S406: the licensing terminal verifies whether the activation ciphertext is correct.

If some operation is performed on the activation ciphertext, a result indicates that the activation ciphertext is correct.

S407: the licensing terminal sends the license ciphertext to the licensed terminal in response to that the activation ciphertext is determined to be correct.

S408: the licensed terminal generates a verification request including the public key, the license ciphertext and second environment ciphertext.

S409: the licensed terminal sends the verification request to the verification terminal.

S410: the verification terminal performs homomorphic decryption on the license ciphertext, obtains the first environment ciphertext therefrom, and verifies authentication of the first environment ciphertext with the second environment ciphertext to obtain verification result ciphertext.

It is assumed that the first environment ciphertext is the same as the second environment ciphertext, it is determined that the license ciphertext is true, and the result that the license ciphertext is true exists in the form of ciphertext, that is, the verification result ciphertext is obtained.

S411: the verification terminal sends the verification result ciphertext to the licensed terminal.

S412: the licensed terminal decrypts the verification result ciphertext with the public key to obtain a verification result, and determines whether to perform license authentication on a service to be licensed according to the verification result.

The video application (the licensed terminal) decrypts the verification result with the locally stored private key, obtains a true verification result, and determines to perform license authentication on movie A with the license ciphertext.

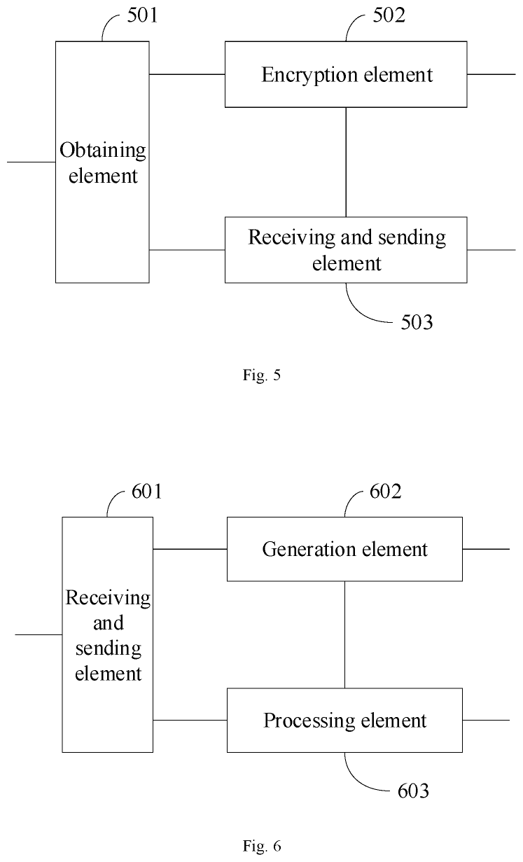

Based on the same inventive concept, an embodiment of the present disclosure provides an apparatus for license authentication applied to a licensing terminal. Reference may be made to description of the method embodiment of the licensing terminal for a specific implementation mode of a method for license authentication for the apparatus, and repetitions will not be described any more. With reference to FIG. 5, the apparatus includes: an obtaining element 501 configured to obtain registration information provided by a licensed terminal, where the registration information includes a public key and first environment ciphertext that are provided by the licensed terminal, the first environment ciphertext is obtained after the licensed terminal encrypts a currently obtained first environment fingerprint with a private key, and the first environment fingerprint includes software and hardware feature information of an environment where the licensed terminal is located; an encryption element 502 configured to generate license information including the first environment ciphertext, encrypt the license information with the public key, and perform homomorphic encryption on encrypted license information to obtain license ciphertext, where the license information is configured to indicate a license range of a service to be licensed that requests license authentication in the licensed terminal; and a receiving and sending element 503 configured to send the license ciphertext to the licensed terminal, cause the licensed terminal to verify the first environment ciphertext in the license ciphertext through a verification terminal to determine authenticity of the license ciphertext, and cause the licensed terminal to determine whether to perform license authentication on the service to be licensed in the licensed terminal according to received verification result ciphertext.

According to a possible implementation mode, the receiving and sending element 503 is further configured to: receive a license request sent by the licensed terminal, where the license request carries activation ciphertext of the service to be licensed, and the activation ciphertext is configured to identify activation of the service to be licensed; verify whether the activation ciphertext is correct; and send the license ciphertext to the licensed terminal in response to that the activation ciphertext is determined to be correct.

According to a possible implementation mode, an algorithm for the homomorphic encryption includes Paillier encryption or fully homomorphic encryption.

Based on the same inventive concept, an embodiment of the present disclosure provides an apparatus for license authentication applied to a licensed terminal. Reference may be made to description of the method embodiment of the licensed terminal for a specific implementation mode of a method for license authentication for the apparatus, and repetitions will not be described any more. With reference to FIG. 6, the apparatus includes: a receiving and sending element 601 configured to send registration information carrying a public key and first environment ciphertext to a licensing terminal, where the first environment ciphertext is obtained after a currently obtained first environment fingerprint is encrypted with a private key, and the first environment fingerprint includes software and hardware feature information of an environment where the licensed terminal is located; where a receiving and sending element 601 is further configured to receive license ciphertext provided by the licensing terminal and generated based on the registration information, where the license ciphertext is obtained after the licensing terminal encrypts license information including the first environment ciphertext with the public key and performs homomorphic encryption on encrypted license information; a generation element 602 configured to generate a verification request including the license ciphertext, second environment ciphertext and the public key, where the second environment ciphertext is obtained after a currently obtained second environment fingerprint is encrypted with the public key, and the second environment fingerprint includes software and hardware feature information of an environment where the licensed terminal is located; where the receiving and sending element 601 is further configured to send the verification request to a verification terminal, cause the verification terminal to verify the first environment ciphertext in the license ciphertext through the second environment ciphertext to determine authenticity of the license ciphertext, and receive verification result ciphertext sent by the verification terminal; and a processing element 603 configured to decrypt the verification result ciphertext with the public key to obtain a verification result, so as to determine whether to perform license authentication on a locally stored service to be licensed according to the verification result.

According to a possible implementation mode, the receiving and sending element 601 is further configured to: generate a key pair including the public key and the private key with a specified key algorithm in response to that an authentication request of the service to be licensed is received, where the authentication request is generated based on an activation operation of a user on the service to be licensed; obtain the first environment fingerprint, and encrypt the first environment fingerprint with the private key to obtain the first environment ciphertext; and send the registration information carrying the public key and the first environment ciphertext to the licensing terminal.

According to a possible implementation mode, the receiving and sending element 601 is further configured to: send a license request carrying activation ciphertext to the licensing terminal, and cause the licensing terminal to verify authenticity of the activation ciphertext, where the activation ciphertext is configured to identify activation of the service to be licensed; and receive the license ciphertext sent by the licensing terminal after the licensing terminal passes verification.

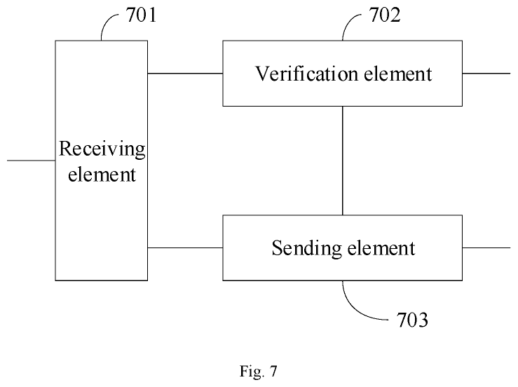

Based on the same inventive concept, an embodiment of the present disclosure provides an apparatus for license authentication applied to a verification terminal. Reference may be made to description of the method embodiment of the verification terminal for a specific implementation mode of a method for license authentication for the apparatus, and repetitions will not be described any more. With reference to FIG. 7, the apparatus includes: a receiving element 701 configured to receive a verification request sent by a licensed terminal, where the verification request is generated by the licensed terminal based on license ciphertext, second environment ciphertext and a public key, the license ciphertext is obtained after a licensing terminal encrypts license information including first environment ciphertext with the public key and performs homomorphic encryption on encrypted license information, the first environment ciphertext is obtained after the licensed terminal encrypts a currently obtained first environment fingerprint with a private key, the second environment ciphertext is obtained after the licensed terminal encrypts a currently obtained second environment fingerprint with the public key, and the first environment fingerprint includes software and hardware feature information of an environment where the licensed terminal is located; a verification element 702 configured to perform homomorphic decryption on the license ciphertext, obtain the first environment ciphertext from license ciphertext subjected to homomorphic decryption, and verify the first environment ciphertext with the second environment ciphertext to obtain verification result ciphertext; and a sending element 703 configured to send the verification result ciphertext to the licensed terminal, and cause the licensed terminal to decrypt the verification result ciphertext with the public key to obtain a verification result, so as to perform license authentication on a service to be licensed in the licensed terminal.

Based on the same inventive concept, an embodiment of the present disclosure provides a server, and the server includes the apparatus for license authentication corresponding to the licensing terminal above.

Based on the same inventive concept, an embodiment of the present disclosure provides an electronic device, and the electronic device includes the apparatus for license authentication corresponding to the licensed terminal and the verification terminal above.

The electronic device may be an advertisement publisher, an artistic screen product, a mobile phone, a tablet device and other display terminals, and may be used for publishing information of multimedia information (words, pictures, videos, etc.). The electronic device may also be applied to new media, smart retail and other industries.

Based on the same inventive concept, an embodiment of the present disclosure provides a system for license authentication, and the system includes the apparatus for license authentication above.

Based on the same inventive concept, an embodiment of the present disclosure provides an apparatus for license authentication, and the apparatus for license authentication includes: at least one processor, and a memory connected to the at least one processor, where the memory stores an instruction executable by the at least one processor, and the at least one processor executes the method for license authentication above by executing the instruction stored in the memory.

Based on the same inventive concept, an embodiment of the present disclosure further provides a readable storage medium. The readable storage medium includes: a memory, where the memory is configured to store an instruction, and when the instruction is executed by a processor, an apparatus including the readable storage medium implements the method for license authentication above.

A person of ordinary skill in the art shall understand that the embodiment of the present disclosure may be provided in the form of a method, a system, or a computer program product. Therefore, the embodiment of the present disclosure may take the form of an entire hardware embodiment, an entire software embodiment, or an embodiment combining software and hardware. Moreover, the embodiment of the present disclosure may take the form of a computer program product implemented on one or more computer usable storage media (including but not limited to a disk memory, a CD-ROM, an optical memory, etc.) encompassing computer usable program codes.

The embodiment of the present disclosure is described with reference to the flowcharts and/or block diagrams of the method, the device (system), and the computer program product according to the embodiment of the present disclosure. It should be understood that each flow and/or block in the flowchart and/or block diagram and a combination of the flow and/or block in the flowchart and/or block diagram may be implemented through computer program instructions. These computer program instructions may be provided for a processor of a general-purpose computer, a special-purpose computer, an embedded processing machine, or other programmable data processing devices to produce a machine, such that instructions executed by the processor of the computer or other programmable data processing device generate an apparatus used for implementing a function specified in one or more flows of the flowchart and/or one or more blocks of the block diagram.

These computer program instructions may also be stored in a computer readable memory that may guide the computer or other programmable data processing device to operate in a specific mode, such that the instructions stored in the computer readable memory produce an article of manufacture including an instruction apparatus, and the instruction apparatus implements the function specified in one or more flows of the flowchart and/or one or more blocks in the block diagram.

These computer program instructions may further be loaded onto the computer or other programmable data processing device, such that a series of operation steps are executed on the computer or other programmable device to generate computer-implemented processing, and the instructions executed on the computer or other programmable device provide steps for implementing the function specified in the one or more flows of the flowchart and/or one or more blocks in the block diagram.

Apparently, those skilled in the art can make various modifications and variations to the present disclosure without departing from the spirit and scope of the present disclosure. Thus, the present disclosure is intended to include such modifications and variations which fall within the scope of the appended claims of the present disclosure and their equivalents as well.

1. A method for license authentication, applied to a licensing terminal, comprising:
obtaining registration information provided by a licensed terminal, wherein the registration information comprises a public key and first environment ciphertext that are provided by the licensed terminal, the first environment ciphertext is obtained after the licensed terminal encrypts a currently obtained first environment fingerprint with a private key, and the first environment fingerprint comprises software and hardware feature information of an environment where the licensed terminal is located;
generating license information comprising the first environment ciphertext, encrypting the license information with the public key, and performing homomorphic encryption on the encrypted license information to obtain license ciphertext, wherein the license information is configured to indicate a license range of a service to be licensed that requests license authentication in the licensed terminal; and
sending the license ciphertext to the licensed terminal, causing the licensed terminal to verify the first environment ciphertext in the license ciphertext through a verification terminal to determine authenticity of the license ciphertext, and causing the licensed terminal to determine whether to perform license authentication on the service to be licensed in the licensed terminal according to received verification result ciphertext.

2. The method according to claim 1, wherein before the sending the license ciphertext to the licensed terminal, the method further comprises:
receiving a license request sent by the licensed terminal, wherein the license request carries activation ciphertext of the service to be licensed, and the activation ciphertext is configured to identify activation of the service to be licensed;
verifying whether the activation ciphertext is correct; and
sending the license ciphertext to the licensed terminal in response to that the activation ciphertext is determined to be correct.

3. The method according to claim 1 or 2, wherein an algorithm for the homomorphic encryption comprises Paillier encryption or fully homomorphic encryption.

4. A method for license authentication, applied to a licensed terminal, and comprising:
sending registration information carrying a public key and first environment ciphertext to a licensing terminal, wherein the first environment ciphertext is obtained after a currently obtained first environment fingerprint is encrypted with a private key, and the first environment fingerprint comprises software and hardware feature information of an environment where the licensed terminal is located;
receiving license ciphertext provided by the licensing terminal and generated based on the registration information, wherein the license ciphertext is obtained after the licensing terminal encrypts license information comprising the first environment ciphertext with the public key and performs homomorphic encryption on the encrypted license information;
generating a verification request comprising the license ciphertext, second environment ciphertext and the public key, wherein the second environment ciphertext is obtained after a currently obtained second environment fingerprint is encrypted with the public key, and the second environment fingerprint comprises software and hardware feature information of an environment where the licensed terminal is located;
sending the verification request to a verification terminal, causing the verification terminal to verify the first environment ciphertext in the license ciphertext through the second environment ciphertext to determine authenticity of the license ciphertext, and receiving verification result ciphertext sent by the verification terminal; and
decrypting the verification result ciphertext with the public key to obtain a verification result, to determine whether to perform license authentication on a locally stored service to be licensed according to the verification result.

5. The method according to claim 4, wherein the sending the registration information carrying the public key and the first environment ciphertext to the licensing terminal comprises:
generating a key pair comprising the public key and the private key with a specified key algorithm in a case that an authentication request of the service to be licensed is received, wherein the authentication request is generated based on an activation operation of a user on the service to be licensed;
obtaining the first environment fingerprint, and encrypting the first environment fingerprint with the private key to obtain the first environment ciphertext; and
sending the registration information carrying the public key and the first environment ciphertext to the licensing terminal.

6. The method according to claim 4, wherein before the receiving the license ciphertext provided by the licensing terminal and generated based on the registration information, the method further comprises:
sending a license request carrying activation ciphertext to the licensing terminal, and causing the licensing terminal to verify authenticity of the activation ciphertext, wherein the activation ciphertext is configured to identify activation of the service to be licensed; and
receiving the license ciphertext sent by the licensing terminal after the licensing terminal passes verification.

7. A method for license authentication, applied to a verification terminal, comprising:
receiving a verification request sent by a licensed terminal, wherein the verification request is generated by the licensed terminal based on license ciphertext, second environment ciphertext and a public key, the license ciphertext is obtained after a licensing terminal encrypts license information comprising first environment ciphertext with the public key and performs homomorphic encryption on the encrypted license information, the first environment ciphertext is obtained after the licensed terminal encrypts a currently obtained first environment fingerprint with a private key, the second environment ciphertext is obtained after a currently obtained second environment fingerprint is encrypted with the public key, and the first environment fingerprint comprises software and hardware feature information of an environment where the licensed terminal is located;
performing homomorphic decryption on the license ciphertext, obtaining the first environment ciphertext from the license ciphertext subjected to the homomorphic decryption, and verifying the first environment ciphertext with the second environment ciphertext to obtain verification result ciphertext; and
sending the verification result ciphertext to the licensed terminal, and causing the licensed terminal to decrypt the verification result ciphertext with the public key to obtain a verification result, to determine whether to perform license authentication on a service to be licensed in the licensed terminal according to the verification result.

8. An apparatus for license authentication, comprising:
a memory, storing instructions; and
at least one processor, connected to the memory and configured to execute the instructions stored in the memory to cause the apparatus to perform the method according to claim 1.

9. An apparatus for license authentication, comprising:
a memory, storing instructions; and
at least one processor, connected to the memory and configured to execute the instructions stored in the memory to cause the apparatus to perform the method according to claim 4.

10. An apparatus for license authentication, comprising:
a memory, storing instructions; and
at least one processor, connected to the memory and configured to execute the instructions stored in the memory to cause the apparatus to perform the method according to claim 7.

11. A server, applied to a licensing terminal, and comprising the apparatus according to claim 8.

12. An electronic device, comprising the apparatuses according to claim 9.

13. A system for license authentication, comprising the apparatus according to claim 8.

14. (canceled)

15. A non-transitory readable storage medium comprising a memory, wherein
the memory is configured to store instructions, and when the instructions are executed by a processor, an apparatus comprising the readable storage medium implements the method according to claim 1.

16. The apparatus according to claim 8, wherein the at least one processor is further configured to execute the instructions stored in the memory to cause the apparatus to perform:
receiving a license request sent by the licensed terminal, wherein the license request carries activation ciphertext of the service to be licensed, and the activation ciphertext is configured to identify activation of the service to be licensed;
verifying whether the activation ciphertext is correct; and
sending the license ciphertext to the licensed terminal in response to that the activation ciphertext is determined to be correct.

17. The apparatus according to claim 8, wherein an algorithm for the homomorphic encryption comprises Paillier encryption or fully homomorphic encryption.

18. The apparatus according to claim 9, wherein the at least one processor is further configured to execute the instructions stored in the memory to cause the apparatus to perform:
generating a key pair comprising the public key and the private key with a specified key algorithm in a case that an authentication request of the service to be licensed is received, wherein the authentication request is generated based on an activation operation of a user on the service to be licensed;
obtaining the first environment fingerprint, and encrypting the first environment fingerprint with the private key to obtain the first environment ciphertext; and
sending the registration information carrying the public key and the first environment ciphertext to the licensing terminal.

19. The apparatus according to claim 9, wherein the at least one processor is further configured to execute the instructions stored in the memory to cause the apparatus to perform:
sending a license request carrying activation ciphertext to the licensing terminal, and causing the licensing terminal to verify authenticity of the activation ciphertext, wherein the activation ciphertext is configured to identify activation of the service to be licensed; and
receiving the license ciphertext sent by the licensing terminal after the licensing terminal passes verification.

20. A non-transitory readable storage medium comprising a memory, wherein
the memory is configured to store instructions, and when the instructions are executed by a processor, an apparatus comprising the readable storage medium implements the method according to claim 4.

21. A non-transitory readable storage medium comprising a memory, wherein
the memory is configured to store instructions, and when the instructions are executed by a processor, an apparatus comprising the readable storage medium implements the method according to claim 7.
